(19) United States
(12) Patent Application Publication
(10) Pub. No.: US 2026/0163522 A1
(43) Pub. Date: Jun. 11, 2026

(54) PHOTOVOLTAIC MODULE MODEL PARAMETER IDENTIFICATION METHOD AND SYSTEM

(71) Applicant: CHINA NATIONAL ELECTRIC APPARATUS RESEARCH INSTITUTE CO., LTD., Guangdong (CN)

(72) Inventors: Nuo CAO, Guangdong (CN); Yonggao FU, Guangdong (CN); Jiaqi HU, Guangdong (CN); Yunhui LIU, Guangdong (CN)

(73) Assignee: CHINA NATIONAL ELECTRIC APPARATUS RESEARCH INSTITUTE CO., LTD., Guangdong (CN)

(21) Appl. No.: 19/537,540

(22) Filed: Feb. 12, 2026

Related U.S. Application Data
(63) Continuation-in-part of application No. PCT/CN2024/124943, filed on Oct. 15, 2024.

(30) Foreign Application Priority Data
Jun. 7, 2024 (CN) 202410736824.9

(51) Int. Cl. H02S 50/10; G01R 31/26

(52) U.S. Cl. CPC H02S 50/10; G01R 31/2603

(57) ABSTRACT

Disclosed is a photovoltaic module model parameter identification method, including the following steps: 1) measuring and recording an I-V curve of a photovoltaic module in a standard test environment; 2) deriving an explicit expression of voltages and currents on the basis of an equivalent circuit of a single-diode model; 3) converting a parameter identification problem into an optimization problem, determining a parameter search space of an objective function in the optimization problem, solving the optimization problem and obtaining five parameter values of the model by means of parameter conversion; and 4) using the explicit expression in step 2) to simulate the I-V curve, and calculating a simulation error. The present disclosure improves a parameter identification method for a single-diode model, which requires only one calculation, thereby reducing the calculation load and improving the accuracy and stability of identification.

### CROSS-REFERENCE TO RELATED APPLICATION

This application is a continuation-in-part of international application of PCT application serial no. PCT/CN2024/124943, filed on Oct. 15, 2024, which claims the priority benefit of China application serial no. 202410736824.9, filed on Jun. 7, 2024, now allowed. The entirety of each of the above-mentioned patent application is hereby incorporated by reference herein and made a part of this specification.

### BACKGROUND

### Technical Field

The present disclosure relates to the technical field of photovoltaic module identification, and specifically refers to a photovoltaic module model parameter identification method and system.

### Description of Related Art

Photovoltaic modules employ a wide array of cell architectures, including, without limitation, PERC, TOPCon, HJT, and perovskite types. In the future, in pursuit of higher photoelectric conversion efficiency and to accommodate diverse application scenarios, the coexistence of multiple cell architectures will likewise remain necessary; however, the types of such architectures and their respective market shares are expected to change. The coexistence of multiple cell types accordingly imposes new requirements on modeling.

Photovoltaic cell models include, inter alia, a single-diode model, a double-diode model, and a power-law model. Among these models, the single diode model (SDM), by virtue of its balanced performance and high applicability, is employed for the modeling of various cells. The SDM is generally associated with an I-V characteristic curve; obtaining the I-V curve from the model constitutes the process of applying the model, whereas obtaining the model parameters from the I-V curve is referred to as parameter identification. Parameter identification constitutes the foundation for the application of the model. Conventional methods principally proceed from solution algorithms which, notwithstanding some achievements, continue to exhibit substantial computational burden and instability in computation.

### SUMMARY

The purpose of the present disclosure is to provide a method and system for photovoltaic module model parameter identification, and the identification method and system are accurate and stable.

The above purpose of the present disclosure is achieved through the following technical solution: a method for photovoltaic module model parameter identification, and the method includes the following steps:
Step 1: acquiring an I-V curve of a module under standard test conditions (STC);
Step 2: deriving an explicit expression of voltages and currents on the basis of an equivalent circuit of a single-diode model (SDM);
Step 3: constructing and solving an optimization problem to obtain three parameter values, and converting the three parameter values to obtain five parameters of the model.

Optionally, in the step 1, the I-V curve of the module under the STC environment is measured according to the requirements in the standard “IEC 61215-2:2021 Terrestrial photovoltaic (PV) modules-Design qualification and type approval—Part 2: Test procedures”.

In the present disclosure, the step 2 specifically includes:
Step 2.1: obtaining an implicit expression of the voltages and the currents based on the single-diode model and Kirchhoff's law:

$$I = {I}_{ph} - {I}_{o} [ exp ( \frac{q ( V + {IR}_{s} )}{{nk}_{B} T} ) - 1 ] - \frac{V + {IR}_{s}}{{R}_{sh}} \qquad ( 1 )$$

Wherein, Rₛ is a series resistance, Rₛₕ is a parallel resistance, I is an electric current of a port, Iₚₕ is a photogenerated current of a cell, Iₒ is a reverse saturation current of a diode, exp is an exponential power of a natural constant e, V is an electric voltage of a port, q is an electron charge (1.6×10⁻¹⁹ C), n is an ideality factor of a diode, kg is a Boltzmann constant (1.38×10⁻²³ J/K), and T is an absolute temperature of the module.
Step 2.2: converting the implicit expression to the explicit expression by introducing a Lambert W function:

$$I = f ( V ) = \frac{{R}_{sh} ( {I}_{ph} + {I}_{o} ) - V}{{R}_{s} + {R}_{sh}} - \frac{n {V}_{t}}{{R}_{s}} W ( \frac{{R}_{s} {R}_{sh} {I}_{o}}{{nV}_{t} ( {R}_{s} + {R}_{sh} )} exp ( \frac{{R}_{sh} ( {R}_{s} {I}_{ph} + {R}_{s} {I}_{o} + V )}{n {V}_{t} ( {R}_{s} + {R}_{sh} )} ) ) \qquad ( 2 )$$

Wherein, ƒ(V) represents a functional relationship with respect to a voltage V,

$${V}_{t} = \frac{{k}_{B} T}{q}$$

is a thermal potential, and W is the Lambert W function.

In the present disclosure, the step 3 specifically includes:
Step 3.1: obtaining a continuous objective function by introducing a derivative of the I-V curve and characteristic information of a short circuit point:

$$g ( x , DIV , V , I ) = K ( DIV \cdot {x}_{1} + 1 ) ( {x}_{2} - V + KI ) + ( K \cdot DIV - 1 ) {x}_{3} \qquad ( 3 )$$

Wherein, g(x, DIV, V, I) represents the continuous objective function,

$$DIV = \frac{dI}{dV} = {f}^{′} ( V )$$

represents a first-order derivative of current with respect to voltage, V represents the port is the characteristic information voltage, I represents the port current,

$${K = \frac{dV}{dI} \vert}_{{I}_{sc}} = - ( {R}_{s} + {R}_{sh} )$$

is the characteristic information of the short circuit point, and x=[x₁, x₂, x₃] represents a vector containing objective function parameters.
Step 3.2: discretizing the continuous objective function g(x, DVI, V, I) to obtain:

$$g ( x , div , v , i ) = k \cdot ( {x}_{1} \cdot div + 1 ) ∘ ( {x}_{2} \cdot 1 - v + k \cdot i ) + {x}_{3} \cdot ( k \cdot div - 1 ) \qquad ( 4 )$$

Wherein, g(x, div, v, i) represents the discrete objective function, ⋅ represents a dot product, ∘ represents a Hadamard product, 1 represents a vector of all ones, div represents a vector composed of sampling points' first-order difference quotients, v represents a vector composed of the sampling points' voltages, i represents a vector composed of the sampling points' current, and k is a resistance value:

$$k = \{ \begin{matrix}\frac{{v}_{j} - {v}_{j - 1}}{{I}_{j} - {I}_{j - 1}} , & {I}_{sc} is unknown \\ \begin{matrix}\frac{{v}_{j - 1}}{{i}_{j - 1} - {I}_{sc}} , {v}_{0} \neq 0 \\ \frac{{v}_{1}}{{i}_{1} - {i}_{0}} , {v}_{0} = 0\end{matrix} \} & {I}_{sc} unknown\end{matrix} \qquad ( 5 )$$

Wherein, I_{sc} is a short circuit current, v₀ and i₀ are a voltage value and a current value of the first sampling point respectively, v₁ and i₁ are a voltage value and a current value of the second sampling point respectively, j is an index of partial data points of the I-V curve, j∈[1, N−1], vⱼ₋₁ and iⱼ₋₁ are a voltage value and a current value of the j-th sampling point respectively, vⱼ and iⱼ are a voltage value and a current value of the (j+1)th sampling point respectively, vⱼ₋₁ satisfies:

$$\vert {v}_{j - 1} \vert \leq \vert {v}_{m - 1} \vert , ∀ m ∈ [ 1 , N - 1 ] \& m ∈ ℤ \qquad ( 6 )$$

Wherein, |⋅| represents an absolute value, vₘ₋₁ is a voltage value of the m-th sampling point, N is the number of data points of the I-V curve, ∀ is an arbitrary symbol, & represents and, and [symbol] represents an integer domain.
Step 3.3: determining a value range of each parameter in the discrete objective function of step 3.2;
Step 3.4: constructing the optimization problem:

$${min}_{x} {‖ g ( x , div , v , i ) ‖}_{2}^{2} s . t . {x}_{m} \leq x \leq {x}_{M} \qquad ( 7 )$$

Wherein, min represents a minimal function,

$${‖ \cdot ‖}_{2}^{2}$$

represents a square of a vector's two-norm, xₘ and x_{M} respectively represent a minimum value and a maximum value of x that is the objective function parameter vector.
Step 3.5: solving the optimization problem to obtain x=[x₁, x₂, x₃];
Step 3.6: converting the objective function parameters into photovoltaic module model parameters, the conversion method is:

$${R}_{s} = {x}_{1} \qquad ( 8 )$$

$${R}_{sh} = - k - {R}_{s} \qquad ( 9 )$$

$$n = - \frac{{x}_{3}}{{kV}_{t}} \qquad ( 10 )$$

$${I}_{ph} = \frac{{x}_{2}}{{R}_{sh}} \qquad ( 11 )$$

$${I}_{o} = \frac{{R}_{sh} {I}_{ph} - {v}_{N - 1} - k {i}_{N - 1}}{{R}_{sh} [ exp ( \frac{{v}_{N - 1} + {R}_{s} {i}_{N - 1}}{{nV}_{t}} ) - 1 ]} \qquad ( 12 )$$

Wherein, v_{N-1} and i_{N-1} are a voltage value and a current value of the N-th sampling point respectively. When an open circuit voltage V_{oc} is given, an equation (12) is simplified to:

$${I}_{o} = \frac{{R}_{sh} {I}_{ph} - {V}_{oc}}{{R}_{sh} [ exp ( \frac{{V}_{oc}}{{nV}_{t}} ) - 1 ]} \qquad ( 13 )$$

The present disclosure may be improved as follows: the method further includes step 4: calculating a simulated current value corresponding to each sampling point voltage in the I-V curve through the explicit expression obtained in step 2.2 and the photovoltaic module model parameters obtained in step 3.6, and calculating a normalized root mean square error of the simulated current, and finally verifying the accuracy and stability of the disclosure by determining whether a simulation error of the algorithm is within a set threshold.

A photovoltaic module model parameter identification system, the system includes:
A data reading module, configured to acquire voltage values and current values of an I-V curve;
A parameter identification module, configured to calculate parameters of a single-diode model;
A simulation calculation module, configured to simulate currents corresponding to voltages at different operating points and calculate a simulation error.

Compared with the related art, the present disclosure has the following advantageous effects:

First, full use is made of the information contained in the I-V curve; by introducing the derivative of the I-V curve and the characteristic information of critical points, the continuous objective function is constructed and thereafter discretized, thereby reducing the number of parameters of the objective function.

Second, the value ranges of parameters are determined based on the objective function, reducing a search space.

Third, more accurate parameter identification results are obtained by converting the parameter identification problem into the optimization problem, thereby reducing model calculation errors.

Fourth, the explicit expression of SDM is utilized to calculate performance indicators of the module, reducing the computational load.

Fifth, the parameter identification method provided by the present disclosure is less affected by the solving algorithm, and the calculation is accurate and stable, thus having a broad applicability.

### BRIEF DESCRIPTION OF THE DRAWINGS

The present disclosure is further described in detail below in conjunction with the accompanying drawings and specific embodiments.

FIG. 1 is a schematic diagram of a single-diode equivalent circuit provided in an embodiment of the present disclosure;

FIG. 2 is a schematic flowchart of a photovoltaic module model parameter identification method in an embodiment of the present disclosure;

FIG. 3A, FIG. 3B, FIG. 3C, and FIG. 3D are algorithm comparison diagrams provided in an embodiment of the present disclosure, wherein FIG. 3A, FIG. 3B, FIG. 3C, and FIG. 3D are actual sampling points and simulation results of different algorithms, specifically: FIG. 3A includes a simulation curve of a genetic algorithm (GA), FIG. 3B includes a simulation curve of particle swarm optimization (PSO), FIG. 3C includes a simulation curve of an interior point method (IPM), FIG. 3D includes a simulation curve of an active set method (ASM).

### DESCRIPTION OF THE EMBODIMENTS

### Embodiment 1

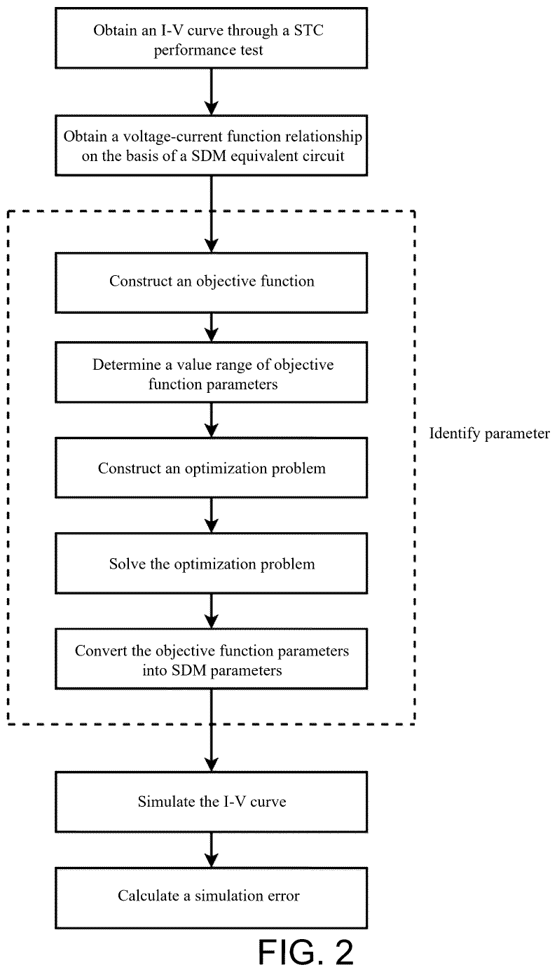

As shown in FIG. 2, an accurate and stable method for calculating parameters of a single-diode model of a photovoltaic module includes the following steps:
Step 1: acquiring an I-V curve of a module under standard test conditions (STC);
Step 2: deriving an explicit expression of voltages and currents on the basis of an equivalent circuit of the single-diode model;
Step 3: converting a parameter identification problem into an optimization problem, solving the optimization problem to obtain three parameter values, and converting the three parameter values to obtain five parameters of the model;
Step 4: applying the single-diode model to obtain a simulation I-V curve, and compare the simulation curve with a real curve to obtain a model calculation error.

The specific process of each step is as follows:

In the step 1, the I-V curve of the module under the STC environment is measured according to the requirements in the standard “IEC 61215-2:2021 Terrestrial photovoltaic (PV) modules-Design qualification and type approval-Part 2: Test procedures”, and the voltage and current values corresponding to each sampling point of the I-V curve are retained.

In step 2, the steps of obtaining the explicit expression of the single diode model include:

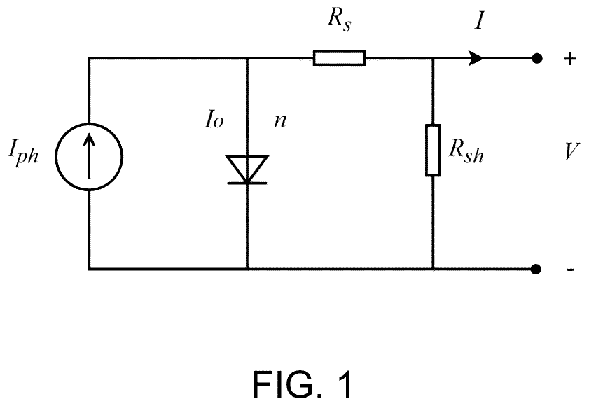

The single diode model (SDM) of the photovoltaic module is improved from a theoretical physical model, which considers a voltage drop of a p-n junction and heat generation during operation. FIG. 1 shows the equivalent circuit of SDM. According to Kirchhoff's law, a functional relationship between current and voltage of a port in FIG. 1 is obtained as:

$$I = {I}_{ph} - {I}_{o} [ exp ( \frac{q ( V + {IR}_{s} )}{{nk}_{B} T} ) - 1 ] - \frac{V + {IR}_{s}}{{R}_{sh}} \qquad ( 1 )$$

Wherein Rₛ is a series resistance, Rₛₕ is a parallel resistance, I is an electric current of a port, Iₚₕ is a photogenerated current of a cell, Iₒ is a reverse saturation current of a diode D, exp is an exponential power of a natural constant e, V is an electric voltage of a port, q is an electron charge (1.6×10⁻¹⁹ C), n is an equivalent diode ideality factor of the module, kg is a Boltzmann constant (1.38×10⁻²³ J/K), T is an absolute temperature of the module. In practice, the measured module temperature unit is Celsius temperature t, and a conversion relationship between T and t is:

$$T = t + 273.15$$

Equation (1) may be simplified as:

$$I = {I}_{ph} - {I}_{o} [ exp ( \frac{( V + {IR}_{s} )}{{nV}_{t}} ) - 1 ] - \frac{V + {IR}_{s}}{{R}_{sh}} \qquad ( 2 )$$

Wherein

$${V}_{t} = \frac{{k}_{B} T}{q}$$

is a thermal potential.

Equation (2) is an implicit expression, where voltages and currents are interrelated, which is inconvenient for calculating performance indicators. By introducing a Lambert W function, the implicit expression is converted to an explicit expression:

$$I = f ( V ) = \frac{{R}_{sh} ( {I}_{ph} + {I}_{o} ) - V}{{R}_{s} + {R}_{sh}} - \frac{{nV}_{t}}{{R}_{s}} W ( \frac{{R}_{s} {R}_{sh} {I}_{o}}{{nV}_{t} ( {R}_{s} + {R}_{sh} )} exp ( \frac{{R}_{sh} ( {R}_{s} {I}_{ph} + {R}_{s} {I}_{o} + V )}{{nV}_{t} ( {R}_{s} + {R}_{sh} )} ) ) \qquad ( 3 )$$

In the equation, ƒ(V) represents a functional relationship with respect to the voltage V, W is the Lambert W function, and the expression is

$$W ( x ) exp ( W ( x ) ) = x \qquad ( 4 )$$

Wherein x is provided to denote a variable.

In step 3, the steps of SDM parameter identification include:
Step 3.1: constructing an objective function.

The direct adoption of an expression f(V)-I as the objective function remains unduly complex, and the number of parameters to be determined is comparatively excessive. On the basis of the explicit expression of the photovoltaic cell circuit, the objective function is simplified by incorporating derivative information of the I-V curve and the key characteristics at a short-circuit point. A resulting initial objective function is as follows:

$$g ( x , DIV , V , I ) = K ( DIV \cdot {x}_{1} + 1 ) ( {x}_{2} - V + KI ) + ( K \cdot DIV - 1 ) {x}_{3} \qquad ( 5 )$$

Wherein g(x, DIV, V, I) represents a continuous objective function,

$$DIV = \frac{dI}{dV} = {f}^{′} ( V )$$

represents a first-order derivative of current with respect to voltage, V represents the port voltage, I represents the port current,

$$K = \frac{dV}{dI} {\vert}_{{I}_{sc}} = - ( {R}_{s} + {R}_{sh} )$$

is characteristic information of the short circuit point, x=[x₁, x₂, x₃] represents a vector containing objective function parameters, and a functional relationship between these parameters and the SDM parameters is as follows:

$${x}_{1} = {R}_{s} \qquad ( 6 )$$

$${x}_{2} = {R}_{sh} ( {I}_{ph} + {I}_{o} ) \qquad ( 7 )$$

$${x}_{3} = - n {V}_{t} K \qquad ( 8 )$$

The existing objective function is a continuous function. In order to apply this function, the variables therein are considered to be discretized to obtain a discrete objective function. Assume that the I-V curve has a total of N data points, and coordinates corresponding to the (j+1)-th data point are (vⱼ, iⱼ). Equation (5) may be discretized as:

$$g ( x , div , v , i ) = k \cdot ( {x}_{1} \cdot div + 1 ) ∘ ( {x}_{2} \cdot 1 - v + k \cdot i ) + {x}_{3} \cdot ( V \cdot div - 1 ) \qquad ( 9 )$$

Wherein g(x, div, v, i) is the discrete objective function, ⋅ represents a dot product, o represents a Hadamard product, 1 represents a vector of all ones, v=[v₁, . . . , vⱼ, . . . v_{N-1}] represents a vector composed of partial sampling points' voltages, j is an index of partial data points of the I-V curve, j∈[1, N−1], i=[i₁, . . . , iⱼ, . . . i_{N-1}] represents a vector composed of the partial sampling points' currents, div=[div₁, . . . , divⱼ, . . . div_{N-1}] represents a vector composed of the sampling points' first-order difference quotients, and k represents a resistance value. The expression of div; is:

$${div}_{j} = \frac{{i}_{j} - {i}_{j - 1}}{{v}_{j} - {v}_{j - 1}} , j ∈ [ 1 , N - 1 ] ∈ ℤ \qquad ( 10 )$$

Wherein div; represents the first-order difference quotient of the (j+1)-th data point.

The expression of k is:

$$k = \{ \begin{matrix}\frac{{v}_{j} - {v}_{j - 1}}{{I}_{j} - {I}_{j - 1}} , {I}_{sc} is unknown \\ \begin{matrix}\frac{{v}_{j - 1}}{{i}_{j - 1} - {I}_{sc}} , & {v}_{0} \neq 0 \\ \frac{{v}_{1}}{{i}_{j} - {i}_{0}} , & {v}_{0} = 0\end{matrix} \} {I}_{sc} known\end{matrix} \qquad ( 11 )$$

Wherein I_{sc} is a short circuit current, v₀ and i₀ are a voltage value and a current value of the first sampling point respectively, v₁ and i₁ are a voltage value and a current value of the second sampling point respectively, vⱼ₋₁ and iⱼ₋₁ are a voltage value and a current value of the j-th sampling point respectively, vⱼ and iⱼ are a voltage value and a current value of the (j+1)-th sampling point respectively, vⱼ₋₁ satisfies:

$$\vert {v}_{j - 1} \vert \leq \vert {v}_{m - 1} \vert , ∀ m ∈ [ 1 , N - 1 ] \& m ∈ ℤ \qquad ( 12 )$$

Wherein |⋅| represents an absolute value, vₘ₋₁ is a voltage value of the m-th sampling point, and ∀ is an arbitrary symbol.
Step 3.2: determining a domain of the objective function parameters.

The objective function of equation (9) contains three parameters, and their domains are respectively:

$${x}_{1} ∈ [ 0 , {R}_{sM} ] \qquad ( 13 )$$

$${x}_{2} ∈ [ - ( k + {R}_{sM} ) {I}_{sc} , - {kI}_{sc} ] \qquad ( 14 )$$

$${x}_{3} ∈ [ - {V}_{t} {N}_{s} k , - 2 {V}_{t} {N}_{s} k ] \qquad ( 15 )$$

Wherein R_{sM} denotes a maximum attainable value of the series resistance Rₛ. Nₛ denotes the number of series-connected cells. I_{sc} denotes a short-circuit current of the module, which may be obtained from the short-circuit point on the I-V curve or by reference to the product specification.
Step 3.3: constructing and solving the optimization problem.

The optimization problem may be constructed by combining the objective function and the domain of the objective function parameter:

$${min}_{x} \vert \vert g ( x , div , v , i ) {\vert \vert}_{2}^{2} s . t . {x}_{m} \leq x \leq {x}_{M} \qquad ( 16 )$$

Wherein min represents a minimal function,

$${‖ \cdot ‖}_{2}^{2}$$

represents a square of a vector's two-norm, x=[x₁, x₂, x₃] represents a vector composed of the objective function parameters, xₘ and x_{M} are a minimum value and a maximum value of x respectively, which are determined in step 3.2.

The computation of the optimization solution requires the specification of an initial value, x₀, to commence an iterative process. Let x₀=[x₁₀, x₂₀, x₃₀]; the respective values thereof are as follows:

$${x}_{10} = \frac{1}{2} {R}_{sM} \qquad ( 17 )$$

$${x}_{20} = - ( k + \frac{1}{2} {R}_{sM} ) {I}_{sc} \qquad ( 18 )$$

$${x}_{30} = - \frac{3}{2} {V}_{t} {N}_{s} k \qquad ( 19 )$$

Preferably, the methods for solving equation (16) are not limited to a single approach and may be classified into metaheuristic algorithms and iterative algorithms. The metaheuristic algorithms further include, without limitation, genetic algorithms, particle swarm algorithms, and the like; the iterative algorithms include, without limitation, interior point methods, active set methods, and the like.
Step 3.4: restoring the objective function parameters to the SDM parameters.

The objective function of the optimization problem contains only three parameters, while the SDM model contains five parameters, therefore after solving the optimization problem, the objective function parameters needs to be restored to the SDM parameters. The expression corresponding to the restoration process is:

$${R}_{s} = {x}_{1} \qquad ( 20 )$$

$${R}_{sh} = - k - {R}_{s} \qquad ( 21 )$$

$$n = - \frac{{x}_{3}}{k {V}_{t}} \qquad ( 22 )$$

$${I}_{ph} = \frac{{x}_{2}}{{R}_{sh}} \qquad ( 23 )$$

$${I}_{o} = \frac{{R}_{sh} {I}_{ph} - {V}_{N - 1} - {kI}_{N - 1}}{{R}_{sh} [ exp ( \frac{{V}_{N - 1} + {R}_{s} {I}_{N - 1}}{{nV}_{t}} ) - 1 ]} \qquad ( 24 )$$

Wherein V_{N-1} and I_{N-1} are a voltage value and a current value of the N-th sampling point respectively. When an open circuit voltage V_{oc} is given, equation (24) is simplified to:

$${I}_{o} = \frac{{R}_{sh} {I}_{ph} - {V}_{oc}}{{R}_{sh} [ exp ( \frac{{V}_{oc}}{n {V}_{t}} ) - 1 ]} \qquad ( 25 )$$

In step 4, the step of simulating the I-V curve is:

With respect to the N sampling points on the I-V curve, the (j+1)-th data point corresponds to voltage and current values (Vⱼ, Iⱼ). A simulated current corresponding to a voltage at each sampling point is computed pursuant to the equation set forth in step 2, and a simulation curve is plotted accordingly. A normalized root-mean-square error (NRMSE) corresponding to the simulated current is hereby defined as:

$$NRMSE = \frac{{\sum }_{j = 0}^{N - 1} {( {\hat{I}}_{j} - {I}_{j} )}^{2}}{{\sum }_{j = 0}^{N - 1} {I}_{j}^{2}} \qquad ( 26 )$$

Wherein Îⱼ represents a simulated current value corresponding to a voltage value Vⱼ of the (j+1)-th data point.

In this embodiment, the I-V curve of the module under the STC environment is measured according to the requirements in the standard “IEC 61215-2:2021 Terrestrial photovoltaic (PV) modules-Design qualification and type approval-Part 2: Test procedures”. Based on the relevant voltage and current data obtained for each sampling point on the I-V curve, parameter identification is conducted pursuant to the prescribed formulae; the specific data and the results of the calculations are set forth below:
S1, the I-V curve of the photovoltaic module is measured in the STC environment, the information of the sampling points on the curve is shown in Table 1:

TABLE 1
Information of sampling points on I-V curve

| Indicator | Point 1 | Point 2 | Point 3 | Point 4 | Point 5 | Point 6 | Point 7 | Point 8 |
|---|---|---|---|---|---|---|---|---|
| Voltage (V) | 0.000 | 1.001 | 2.005 | 3.008 | 4.000 | 5.003 | 6.008 | 7.001 |
| Current (A) | 5.5238 | 5.5194 | 5.5150 | 5.5106 | 5.5063 | 5.5019 | 5.4975 | 5.4931 |
| | Point 9 | Point 10 | Point 11 | Point 12 | Point 13 | Point 14 | Point 15 | Point 16 |
| Voltage (V) | 8.000 | 9.002 | 10.009 | 11.002 | 12.004 | 13.000 | 14.002 | 15.001 |
| Current (A) | 5.4888 | 5.4844 | 5.4800 | 5.4756 | 5.4713 | 5.4669 | 5.4625 | 5.4581 |
| | Point 17 | Point 18 | Point 19 | Point 20 | Point 21 | Point 22 | Point 23 | Point 24 |
| Voltage (V) | 16.002 | 17.002 | 18.002 | 19.006 | 20.008 | 21.003 | 22.007 | 23.007 |
| Current (A) | 5.4538 | 5.4494 | 5.4450 | 5.4406 | 5.4360 | 5.4318 | 5.4274 | 5.4229 |
| | Point 25 | Point 26 | Point 27 | Point 28 | Point 29 | Point 30 | Point 31 | Point 32 |
| Voltage (V) | 24.002 | 25.005 | 26.008 | 27.005 | 28.002 | 29.002 | 30.001 | 31.005 |
| Current (A) | 5.4184 | 5.4138 | 5.4091 | 5.4042 | 5.3989 | 5.3930 | 5.3862 | 5.3777 |
| | Point 33 | Point 34 | Point 35 | Point 36 | Point 37 | Point 38 | Point 39 | Point 40 |
| Voltage (V) | 32.010 | 33.004 | 34.004 | 35.005 | 36.007 | 37.008 | 38.003 | 39.002 |
| Current (A) | 5.3667 | 5.3516 | 5.3297 | 5.2969 | 5.2467 | 5.1698 | 5.0531 | 4.9775 |
| | Point 41 | Point 42 | Point 43 | Point 44 | Point 45 | Point 46 | Point 47 | Point 48 |
| Voltage (V) | 40.006 | 41.001 | 42.003 | 43.005 | 44.010 | 45.001 | 46.007 | 46.601 |
| Current (A) | 4.6204 | 4.2641 | 3.7856 | 3.1776 | 2.4380 | 1.5893 | 0.6190 | 0.0004 |

Wherein a resolution of the voltage is 1 mV, and a resolution of the current is 0.1 mA.

S2, let

$${R}_{sM} = 1 Ω , {N}_{s} = 72 , {I}_{sc} = 5.5238 A , {V}_{t} = 0.0257 V , k = \frac{1001}{5.5194 - 5.5238} = - 22 \; 7.5 Ω ,$$

thus the optimization problem may be constructed:

$${min}_{{x}_{1} , {x}_{2} , {x}_{3}} {‖ g ( x , div , v , i ) ‖}_{2}^{2}$$

$$s . t . 0 \leq {x}_{1} \leq 1 , 1251.1 \leq {x}_{2} \leq 1256.7 , 421.0 \leq {x}_{3} \leq 841.9$$

Wherein v=[v₁, v₂, . . . , v₄₇]=[1.001, 2.005, . . . , 46.601], i=[i₁, i₂, . . . , i₄]=[5.5194, 5.5150, . . . , 0.004], div=[div₁, div₂, . . . , div₄₇]=[−0.0044, −0.0044, . . . , −1.0414], x=[x₁, x₂, x₃].

With an initial iterate x₀=[0.5, 1253.9, 631.45], the optimization problem is solved by means of a genetic algorithm (GA), a particle swarm optimization (PSO), an interior point method (IPM), and an active set method (ASM), whereupon the solution parameters are converted into the model parameters. The parameter identification results obtained by the respective algorithms are as set forth in Table 2.

TABLE 2
Parameter identification results of four typical algorithms

| Algorithm | Rₛ(Ω) | Rₛₕ(Ω) | n | Iₚₕ(A) | Iₒ(A) |
|---|---|---|---|---|---|
| GA | 0.498 | 227.003 | 97.534 | 5.536 | 4.545 × 10⁻⁸ |
| PSO | 0.494 | 227.006 | 98.030 | 5.536 | 4.992 × 10⁻⁸ |
| IPM | 0.494 | 227.006 | 98.030 | 5.536 | 4.992 × 10⁻⁸ |
| ASM | 0.494 | 227.006 | 98.030 | 5.536 | 4.992 × 10⁻⁸ |

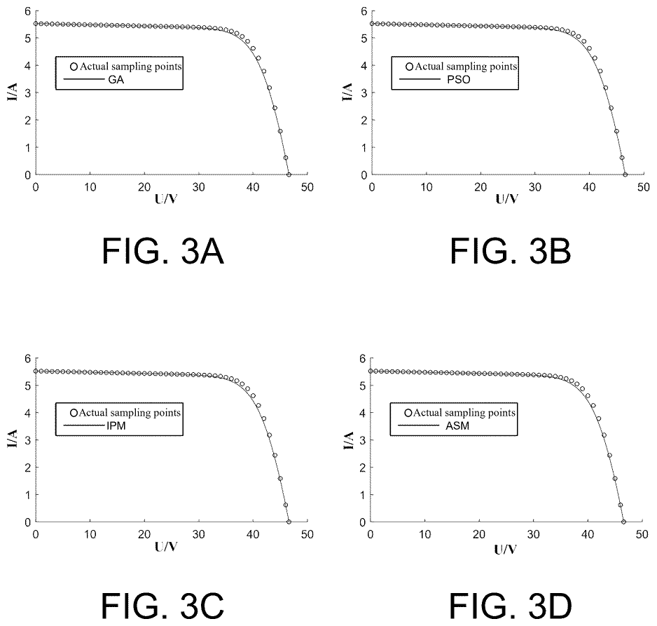

In S3, and pursuant to equations (3) and (4) of step 2, the simulated current corresponding to each sampling point voltage is obtained; actual values and simulated values are shown in FIGS. 3A-3D. The simulation curves for the four algorithms in FIG. 3A, FIG. 3B, FIG. 3C and FIG. 3D are closely aligned, indicating that the parameter identification method is minimally affected by the choice of solution algorithm and that the algorithms are stable. The simulation errors for the four algorithms, computed in accordance with equation (26), are set forth in Table 3.

TABLE 3
Simulation errors of four algorithms

| Simulation | | | | |
|---|---|---|---|---|
| error | GA | PSO | IPM | ASM |
| NRMSE | 0.014 | 0.005 | 0.014 | 0.005 |

As can be seen from Table 3, the errors of various algorithms in the table are all within the range of (0,0.1), and accurate fitting results are obtained.

### Embodiment 2

This embodiment provides a photovoltaic module model parameter identification system, and the system includes:
A data reading module, configured to acquire voltage values and current values of the I-V curve;
A parameter identification module, configured to calculate parameter values of a single-diode model;
A simulation calculation module, configured to simulate currents corresponding to voltages at different operating points and calculate simulation errors.

### Embodiment 3

This embodiment provides a computer-readable storage medium. The computer-readable storage medium is configured to store a computer program, and when the computer program is executed by a processor, the photovoltaic module model parameter identification process described in Embodiment 1 is implemented.

### Embodiment 4

This embodiment provides an electronic device capable of identifying photovoltaic module model parameters. In a specific implementation, the electronic device may be in the form of a user terminal, for example, the electronic device may be, but is not limited to, a server, a smartphone, a personal computer, or an embedded system, etc.

The electronic device may have an I-V curve acquisition module, or have a data interface capable of communicating with an I-V curve scanner, so as to acquire data points collected by the I-V curve scanner.

The electronic device may have an I-V curve parameter calculation module, for example, a central processing unit, or a graphics processing unit, etc., and have a memory for storing a computer program. When the electronic device is operating, the processor reads data from the I-V curve acquisition module and executes the computer program stored in the memory, so that the electronic device executes the photovoltaic module model parameter identification method provided in Embodiment 1 of the present disclosure.

The electronic device may also have an I-V curve data storage module, for example, a mechanical hard disk, a portable hard disk, a memory card, etc., so that the I-V curve data points provided in this embodiment, as well as the parameter identification values obtained by executing the photovoltaic module model parameter identification method provided in this embodiment through the computer program, may also be stored and used for output display.

What is claimed is:

1. A photovoltaic module model parameter identification method, comprising the following steps:
step 1: acquiring an I-V curve of a photovoltaic module under standard test conditions (STC);
step 2: deriving an explicit expression of voltages and currents based on an equivalent circuit of a single-diode model;
step 3: constructing and solving an optimization problem to obtain three parameter values, and converting the three parameter values to obtain five parameters of a photovoltaic module model.

2. The photovoltaic module model parameter identification method according to claim 1, wherein the step 2 comprises:
step 2.1: obtaining an implicit expression of the voltages and the currents based on the single-diode model and Kirchhoff's law:
$$I = {I}_{p h} - {I}_{o} [ exp ( \frac{q ( V + {IR}_{s} )}{n {k}_{B} T} ) - 1 ] - \frac{V + {IR}_{s}}{{R}_{s h}} \qquad ( 1 )$$
wherein, Rₛ is a series resistance, Rₛₕ is a parallel resistance, I is an electric current of a port, Iₚₕ is a photogenerated current of a cell, Iₒ is a reverse saturation current of a diode, exp is an exponential power of a natural constant e, V is an electric voltage of a port, q is an electron charge (1.6×10⁻¹⁹ C), n is an ideality factor of a diode, kg is a Boltzmann constant (1.38×10⁻²³ J/K), T is an absolute temperature of the photovoltaic module;
step 2.2: converting the implicit expression to the explicit expression by introducing a Lambert W function:
$$\begin{matrix}I = f ( V ) \\ = \frac{{R}_{s h} ( {I}_{p h} + {I}_{o} ) - V}{{R}_{s} + {R}_{s h}} - \\ \frac{n {V}_{t}}{{R}_{s}} W ( \frac{{R}_{s} {R}_{s h} {I}_{o}}{n {V}_{t} ( {R}_{s} + {R}_{s h} )} exp ( \frac{{R}_{s h} ( {R}_{s} {I}_{p h} + {R}_{s} {I}_{o} + V )}{n {V}_{t} ( {R}_{s} + {R}_{s h} )} ) )\end{matrix} \qquad ( 2 )$$
in the equation, ƒ(V) represents a functional relationship with respect to a voltage set V,
$${V}_{t} = \frac{{k}_{B} T}{q}$$
is a thermal potential, and W is the Lambert W function.

3. The photovoltaic module model parameter identification method according to claim 2, wherein the step 3 comprises:
step 3.1: obtaining a continuous objective function by introducing a derivative of the I-V curve and characteristic information of a short circuit point:
$$g ( x , DIV , V , I ) = K ( DIV \cdot {x}_{1} + 1 ) ( {x}_{2} - V + KI ) + ( K \cdot DIV - 1 ) {x}_{3} \qquad ( 3 )$$
wherein, g(x, DIV, V, I) represents the continuous objective function,
$$DIV = \frac{dI}{d V} = {f}^{′} ( V )$$
represents a first-order derivative of current with respect to voltage, V represents a port voltage, I represents a port current,
$$K = \frac{d V}{dI} {\vert}_{{I}_{sc}} = - ( {R}_{s} + {R}_{s h} )$$
is the characteristic information of the short circuit point, x=[x₁, x₂, x₃] represents a vector containing objective function parameters;
step 3.2: discretizing the continuous objective function g(x, DVI,V, I) to obtain:
$$g ( x , div , v , i ) = k \cdot ( {x}_{1} \cdot div + 1 ) ∘ ( {x}_{2} \cdot 1 - v + k \cdot i ) + {x}_{3} \cdot ( k \cdot div - 1 ) \qquad ( 4 )$$
wherein, g(x, div, v, i) represents a discrete objective function, ⋅ represents a dot product, ∘ represents a Hadamard product, 1 represents a vector of all ones, div represents a vector composed of first-order difference quotients of sampling points, v represents a vector composed of voltages of the sampling points, i represents a vector composed of currents of the sampling points, and k is a resistance value:
$$k = \{ \begin{matrix}\frac{{v}_{j} - {v}_{j - 1}}{{I}_{j} - {I}_{j - 1}} , & {I}_{sc} is unknown \\ \begin{matrix}\frac{{v}_{j - 1}}{{i}_{j - 1} - {I}_{sc}} , {v}_{0} \neq 0 \\ \frac{{v}_{1}}{{i}_{1} - {i}_{o}} , {v}_{0} = 0\end{matrix} \} & {I}_{sc} known\end{matrix} \qquad ( 5 )$$
wherein, I_{sc} is a short circuit current, v₀ and i₀ are a voltage value and a current value of a first sampling point respectively, v₁ and i₁ are a voltage value and a current value of a second sampling point respectively, j is an index of partial data points of the I-V curve, j∈[1, N−1], vⱼ₋₁ and iⱼ₋₁ are a voltage value and a current value of the j-th sampling point respectively, vⱼ and iⱼ are a voltage value and a current value of the (j+1)th sampling point respectively, vⱼ₋₁ satisfies:
$$\vert {v}_{j - 1} \vert \leq \vert {v}_{m - 1} \vert , ∀ m ∈ [ 1 , N - 1 ] \& m ∈ ℤ \qquad ( 6 )$$
wherein, |⋅| represents an absolute value, vₘ₋₁ is a voltage value of the m-th sampling point, N is the number of data points of the I-V curve, ∀ is an arbitrary symbol, & represents and, and [symbol] represents an integer domain;
step 3.3: determining a value range of each parameter in the discrete objective function of step 3.2;
step 3.4: constructing the optimization problem:
$${min}_{x} {‖ g ( x , div , v , i ) ‖}_{2}^{2} s . t . {x}_{m} \leq x \leq {x}_{M} \qquad ( 7 )$$
wherein, min represents a minimal function,
$${‖ \cdot ‖}_{2}^{2}$$
represents a square of a vector's two-norm, xₘ and x_{M} respectively represent a minimum value and a maximum value of x that is the objective function parameter vector;
step 3.5: solving the optimization problem to obtain the objective function parameter vector x=[x₁, x₂, x₃];
step 3.6: converting the objective function parameters into photovoltaic module model parameters, a way to convert is:
$${R}_{s} = {x}_{1} \qquad ( 8 )$$
$${R}_{s h} = - k - {R}_{s} \qquad ( 9 )$$
$$n = - \frac{{x}_{3}}{k {V}_{t}} \qquad ( 10 )$$
$${I}_{p h} = \frac{{x}_{2}}{{R}_{s h}} \qquad ( 11 )$$
$${I}_{o} = \frac{{R}_{s h} {I}_{p h} - {v}_{N - 1} - k {i}_{N - 1}}{{R}_{s h} [ exp ( \frac{{v}_{N - 1} + {R}_{s} {i}_{N - 1}}{n {V}_{t}} ) - 1 ]} \qquad ( 12 )$$
wherein, V_{N-1} and i_{N-1} are a voltage value and a current value of the N-th sampling point respectively, when an open circuit voltage V_{oc} is given, an equation (12) is simplified to:
$${I}_{o} = \frac{{R}_{s h} {I}_{p h} - {V}_{o c}}{{R}_{s h} [ exp ( \frac{{V}_{o c}}{n {V}_{t}} ) - 1 ]} . \qquad ( 13 )$$

4. The photovoltaic module model parameter identification method according to claim 3, wherein the method further comprises step 4: calculating a simulated current value corresponding to each sampling point voltage in the I-V curve through the explicit expression obtained in step 2.2 and the photovoltaic module model parameters obtained in step 3.6, and calculating a normalized root mean square error of the simulated currents, and finally verifying accuracy and stability of the method by determining whether a simulation error is within a set threshold.

5. A photovoltaic module model parameter identification system, wherein the system comprises:
a data reading module, configured to acquire voltage values and current values of an I-V curve;
a parameter identification module, configured to calculate parameter values of a single-diode model;
a simulation calculation module, configured to simulate currents corresponding to voltages at different operating points and calculate a simulation error.

6. An electronic device, comprising: a photovoltaic module I-V curve acquisition part, a processor, a memory and a computer program; wherein, the I-V curve acquisition part and the memory are connected with the processor, the computer program is stored in the memory, when the electronic device is operating, the processor reads data of the I-V curve acquisition part, executes the computer program stored in the memory, so that the electronic device executes and implements the photovoltaic module model parameter identification method according to claim 1.
